(19) United States
(12) Patent Application Publication
(10) Pub. No.: US 2025/0298330 A1
(43) Pub. Date: Sep. 25, 2025

(54) TONER AND TWO-COMPONENT DEVELOPER CONTAINING SAME

(71) Applicant: SHARP KABUSHIKI KAISHA, Sakai City (JP)

(72) Inventor: KEIICHI KIKAWA, Sakai City (JP)

(21) Appl. No.: 19/052,512

(22) Filed: Feb. 13, 2025

(30) Foreign Application Priority Data
Mar. 19, 2024 (JP) 2024-044081

(51) Int. Cl. G03G 9/08; G03G 9/087; G03G 9/09; G03G 9/097

(52) U.S. Cl. CPC G03G 9/0825; G03G 9/081; G03G 9/0819; G03G 9/08755; G03G 9/0904; G03G 9/0918; G03G 9/09708

(57) ABSTRACT

A toner containing at least toner core particles and an external additive component externally added to the surface of the toner core particle, wherein the external additive component contains at least titanium oxide particles, zinc oxide particles, and an external additive, wherein the titanium oxide particles and the zinc oxide particles have average primary particle sizes of from 75 to 200 nm and from 80 to 300 nm, respectively, and wherein, when external addition rates of the titanium oxide particles and the zinc oxide particles with respect to the toner core particles are defined as A mass % and B mass %, respectively, the toner satisfies relationships of formula (1): 0.5≤A/B≤2.0; and formula (2): 7≤(A+B)≤12.

### TECHNICAL FIELD

The disclosure relates to a toner and a two-component developer including the same.

### BACKGROUND ART

Since metals such as copper and silver have antibacterial action, they have been used in tableware, coins and the like. Taking the recent pandemic as an opportunity, various products to which their antibacterial and antiviral actions are imparted have been developed anew. For example, a material into which such an antibacterial agent is kneaded is formed into a desired shape such as a sheet, or a liquid in which such an antibacterial agent is dispersed is sprayed onto an object, thereby causing the product to exhibit antibacterial properties.

Further, a technique has been proposed in which an antibacterial agent is kneaded into an electrophotographic toner to impart antibacterial properties to the surface of the toner fixed on a printed matter.

For example, there has been proposed a covering method in which the surface of an image body is covered with a transparent toner containing an antibacterial agent and then the toner is fixed to impart antibacterial properties to the image body. In addition, there has been proposed an image forming method capable of stably forming an image having antibacterial properties and antiviral properties by using a toner containing a binder resin, a release agent, and particles composed of an inorganic antibacterial antiviral agent satisfying specific requirements, and silver, copper, zinc, titanium oxide, and the like have been proposed as the inorganic antibacterial antiviral agent.

### SUMMARY

However, the above-described prior art cannot impart sufficient antibacterial properties to the surface of a fixed toner on a printed matter. The reasons for this are considered to be that: (1) when an antibacterial component is internally added to a toner, the antibacterial component is less likely to be exposed onto the surface at the time of fixing; (2) the effect obtained by a single antibacterial component is not sufficient; (3) when a large amount of a single antibacterial component is externally added to a toner, thereby obtaining a sufficient antibacterial effect, the antibacterial component is detached from the toner surface, and only a toner having a high charging power is selectively developed and fixed to reduce the antibacterial component on a printed matter; and the like.

Accordingly, an object of the disclosure is to provide a toner that has chargeability enough to be developed and can exhibit antibacterial properties even after being fixed to a printed matter, and a two-component developer including the toner.

As a result of intensive studies to solve the above problems, the inventors have found that, by externally adding titanium oxide particles and zinc oxide particles having a specific average primary particle size to toner core particles at a specific ratio, excellent antibacterial properties can be exhibited while chargeability is maintained, and that the above problems can be solved, and have completed the disclosure.

Thus, according to the disclosure, there is provided a toner containing at least toner core particles and an external additive component externally added to the surface of the toner core particle,
wherein the external additive component contains at least titanium oxide particles, zinc oxide particles, and an external additive,
wherein the titanium oxide particles and the zinc oxide particles have average primary particle sizes of from 75 to 200 nm and from 80 to 300 nm, respectively, and
wherein, when external addition rates of the titanium oxide particles and the zinc oxide particles with respect to the toner core particles are defined as A mass % and B mass %, respectively, the toner satisfies relationships of the following formulas (1) and (2):

$$0.5 \leq A / B \leq 2. \qquad ( 1 )$$

$$7 \leq ( A + B ) \leq 12. \qquad ( 2 )$$

Moreover, according to the disclosure, there is provided a two-component developer containing the toner described above and a carrier.

According to the disclosure, there can be provided a toner that has chargeability enough to be developed and can exhibit antibacterial properties even after being fixed to a printed matter, and a two-component developer including the toner.

### BRIEF DESCRIPTION OF DRAWINGS

FIG. 1 is an SEM image of a toner of the disclosure;

FIG. 2 is an SEM image of titanium oxide particles externally added to the toner of the disclosure;

FIG. 3 is an SEM image of zinc oxide particles externally added to the toner of the disclosure;

FIG. 4 is a schematic view illustrating a mechanism of the toner of the disclosure to exhibit antibacterial properties;

FIG. 5 is a table showing constituent components of toner core particles of Examples 1 to 9 and their physical property values;

FIG. 6 is a table showing constituent components of toner core particles of Examples 10 to 20 and their physical property values;

FIG. 7 is a table showing constituent components of toner core particles of Comparative Examples 1 to 10 and their physical property values; and

FIG. 8 is a table showing evaluation results of Examples and Comparative Examples.

### DETAILED DESCRIPTION OF THE DISCLOSURE

Hereinafter, “mechanism” of the toner of the disclosure “to exhibit antibacterial properties”, and its main constituent components “titanium oxide particles and zinc oxide particles”, “external additive”, and “conductive agent” will be described, and (1) the toner, (2) a production method therefor, (3) a two-component developer including the toner of the disclosure, and (4) applications thereof will be described.

### Mechanism to Exhibit Antibacterial Properties

In general, the mechanism of the antibacterial agent to exhibit antibacterial properties has not been elucidated in many cases, and the following mechanisms are presumed.
(1) The antibacterial agent deprives water of electrons to generate an OH radical (·OH), which breaks down cell membranes of bacteria to stop the activity of the bacteria. Further, the antibacterial agent gives electrons to oxygen in the air to generate a superoxide anion (O²⁻), which breaks down cell membranes of bacteria to stop the activity of the bacteria.

This effect is more effective as the surface area of the antibacterial agent is larger and there are more opportunities of contact with bacteria and viruses because the substance exerting the antibacterial action is a relatively unstable substance such as a radical and acts on bacteria and viruses in the vicinity of the surface of the antibacterial agent.
(2) Positively charged metal ions are generated from the antibacterial agent, come into contact with negatively charged bacteria and viruses, and enter the inside thereof, thereby binding to proteins to stop the activity.

This effect lasts longer than the effect (1) because the antibacterial action is exhibited by the metal ions, and is more effective as the total number of generated metal ions is larger.

In the toner of the disclosure, titanium oxide and zinc oxide, each of which exhibits antibacterial properties even alone, exhibit an antibacterial effect by virtue of a synergistic effect.

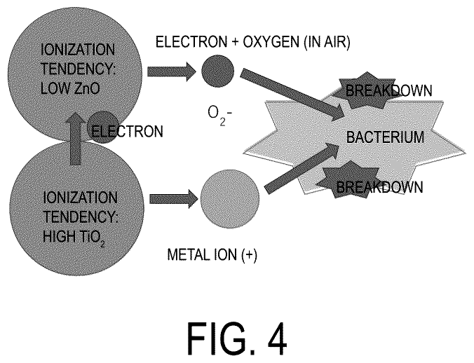

FIG. 4 is a schematic view illustrating the mechanism of the toner of the disclosure to exhibit the antibacterial properties, and description will be made based on this.

When titanium oxide having a relatively high ionization tendency comes into contact with zinc oxide having a relatively low ionization tendency, titanium oxide deprives zinc oxide of electrons to form metal ions. The metal ions come into contact with bacteria and viruses and enter the inside thereof, thereby binding to proteins to stop the activity of the bacteria (see the above effect (2) and the lower part of FIG. 4). On the other hand, zinc oxide which has deprived titanium oxide of electrons gives electrons to oxygen in the air to generate a superoxide anion (O²⁻), which breaks down the cell membrane of bacteria to stop the activity of the bacteria (see the above effect (1) and the upper part of FIG. 4).

In order for a printed matter to which a toner added with an antibacterial agent is fixed to exhibit sufficient antibacterial properties, the antibacterial agent needs to be exposed onto the surface of the toner in a state where the toner is fixed to an object to be printed. When a small amount of the antibacterial agent is added, the effect is low. When a large amount of the antibacterial agent is added, the antibacterial agent, if having conductivity, affects the charging performance of the toner, and efficient development cannot be performed.

In the toner of the disclosure, the antibacterial power is enhanced by the synergistic effect between titanium oxide and zinc oxide, and thus the total addition amount of titanium oxide and zinc oxide to be added can be reduced, and development can be performed without problems even when the toner is charged as in the related art, and sufficient antibacterial properties can be imparted to a printed matter.

In order to sufficiently bring out the synergistic effect between titanium oxide and zinc oxide, it is necessary to bring them into contact with each other efficiently, and preferable conditions therefor are shown below.

### Titanium Oxide Particles and Zinc Oxide Particles

### Average Primary Particle Size

In the toner of the disclosure, the titanium oxide particles and the zinc oxide particles have average primary particle sizes of from 75 to 200 nm and from 80 to 300 nm, respectively.

When the average primary particle size of the titanium oxide particles is less than 75 nm, the aggregation force of the particles becomes high and the particles become difficult to disperse, so that a desired effect may not be obtained. On the other hand, when the average primary particle size of the titanium oxide particles exceeds 200 nm, the particles are easily detached from the toner surface, and even if the particles are not detached, adverse effects such as local electric leakage may occur, and the desired effect may not be obtained.

The average primary particle size of the titanium oxide particles is preferably from 80 to 150 nm, and more preferably from 85 to 100 nm.

When the average primary particle size of the zinc oxide is less than 80 nm, the aggregation force of the particles becomes high and the particles become difficult to disperse, so that the desired effect may not be obtained. On the other hand, when the average primary particle size of the zinc oxide exceeds 300 nm, the particles are easily detached from the toner surface, and even if the particles are not detached, adverse effects such as local electric leakage may occur, and the desired effect may not be obtained.

The average primary particle size of the zinc oxide particles is preferably from 85 to 200 nm, more preferably from 90 to 150 nm.

If the difference in particle diameter between the two particles is too large, the contact area or contact opportunity between the two particles decreases, and the synergistic effect may not be efficiently obtained. From such a viewpoint, the particle diameters of the two particles are preferably substantially the same.

In addition, since the particle shape also affects the contact area and the contact opportunity between the two particles, it is necessary to consider the particle shapes in setting the optimum particle diameters of both particles.

The titanium oxide particles have a relatively cubic shape, whereas the zinc oxide particles have a shape in which columnar particles are frequently observed. Therefore, the zinc oxide particles preferably have a particle size range slightly larger than that of the titanium oxide particles as described above in terms of a spherical equivalent diameter.

The method for measuring the average primary particle sizes of the titanium oxide particles and the zinc oxide particles will be described in Examples.

### External Addition Rate Ratio

The toner of the disclosure has an external addition rate ratio A/B between the titanium oxide particles and the zinc oxide particles satisfying a relationship of the following formula (1):
0.5≤A/B≤2.0 (1). When one of the particles is unevenly present, the contact opportunity between the particles is reduced, and thus the final result is expected to be the same as that obtained when the particles are singly added. It is considered that at least one of the particles needs to have an external addition rate of about half of that of the other. When this relationship is satisfied, a synergistic effect between the titanium oxide particles and the zinc oxide particles is exhibited, and antibacterial performance can be enhanced.

When the external addition rate ratio A/B is less than 0.5, the amount of titanium oxide is too small, and when the external addition rate ratio A/B is more than 2.0, the amount of zinc oxide is too small, and thus a sufficient synergistic effect may not be obtained.

The external addition rate ratio A/B is preferably 0.7 or more and 1.5 or less, and more preferably 0.8 or more and 1.2 or less.

### Total External Addition Rate

The toner of the disclosure has a total external addition rate (A+B) of the titanium oxide particles and the zinc oxide particles as the external additive components satisfying a relationship of the following formula (2):
7≤(A+B)≤12 (2). When this relationship is satisfied, a synergistic effect between the titanium oxide particles and the zinc oxide particles is exhibited, and antibacterial performance can be enhanced.

When the total external addition rate (A+B) is less than 7 mass %, a sufficient antibacterial effect may not be obtained. On the other hand, when the total external addition rate (A+B) exceeds 12 mass %, sufficient chargeability may not be obtained, and developability may be deteriorated.

The total external addition rate (A+B) is preferably 8 mass % or more and 11.5 mass % or less, and more preferably 9 mass % or more and 11 mass % or less.

### External Addition Ratio

When the external addition rates of the titanium oxide particles, the zinc oxide particles and the external additive with respect to the toner core particles are defined as A mass %, B mass % and E mass %, respectively, the toner of the disclosure preferably satisfies a relationship of the following formula (3):

$$2.5 \leq ( A + B ) / E \leq 20. \qquad ( 3 )$$

When the ratio (A+B)/E is less than 2.5, the fluidity of the toner may be insufficient. On the other hand, when the ratio (A+B)/E exceeds 20, the charging performance of the toner may be adversely affected.

The ratio (A+B)/E is more preferably 5 or more and 15 or less, and particularly preferably 7 or more and 10 or less.

### Adhesion Strength

In the toner of the disclosure, each of the titanium oxide particles and the zinc oxide particles preferably has an adhesion strength of from 60 to 100%.

When the adhesion strength is less than 60%, detachment of particles from the toner surface increases and the amount of free particles increases, which may adversely affect the charging performance of the toner.

The adhesion strength is more preferably from 70 to 97%, and particularly preferably from 80 to 95%.

The method for measuring the adhesion strength will be specifically described in Examples.

### Surface Treatment and Hydrophobization Rate

Surface-untreated titanium oxide particles and zinc oxide particles exhibit hydrophilicity, and when these particles are externally added to the toner, they cause aggregation and cannot be externally added in a highly dispersed state. Therefore, in the toner of the disclosure, the titanium oxide particles and the zinc oxide particles are preferably appropriately subjected to a surface (hydrophobization) treatment.

By subjecting these particles to a surface treatment, aggregation of the particles can be prevented. In addition, since these particles become easily compatible with the binder resin of the toner, when these particles are externally added to the toner core particles, the adhesion strength to the toner surface is improved, and an effect of making the particles difficult to detach can be expected.

As the surface treatment method, a known method can be applied, and examples of the surface treatment agent include a silane coupling agent, a titanium coupling agent, a silicone oil, and hydrogen methicone.

A degree of the surface treatment can be represented by the hydrophobization rate, and in the toner of the disclosure, each of the titanium oxide particles and the zinc oxide particles preferably has a hydrophobization rate of from 40 to 80%.

When the hydrophobization rate is less than 40%, an effect of preventing aggregation of the particles may be insufficient. On the other hand, when the hydrophobization rate exceeds 80%, the contact opportunity with water or oxygen for generating radicals decreases, and similarly, the contact between the particles and the contact between the particles and the conductive agent are prevented, and the antibacterial effect may be deteriorated.

The hydrophobization rate is preferably from 45 to 75%, and particularly preferably from 50 to 70%.

The method for measuring the hydrophobization rate will be specifically described in Examples.

### External Additive

The external additive has functions to improve powder flowability, to improve triboelectric chargeability, to improve heat resistance/long-term storage stability, to improve cleaning characteristics, and to control photoreceptor surface abrasion characteristics.

Examples of the external additive include inorganic fine particles such as silica particles, titanium oxide and alumina particles having an average primary particle size of from 7 to 200 nm. Inorganic fine particles to which hydrophobicity is imparted by subjecting the surfaces of these inorganic fine particles to a surface treatment with a silane coupling agent, a titanium coupling agent, or a silicone oil are more preferable because decreases in electric resistance and charge amount in a high-humidity environment are small. Among them, surface-treated silica particles are particularly preferable.

### Surface-Treated Silica Particles

Examples of the surface-treated silica particles include silica particles surface-treated with dimethyldichlorosilane (dimethylsilyl: DDS), hexamethyldisilazane (trimethylsilyl: HMDS), a silicone oil (dimethylpolysiloxane), and the like. Silica particles surface-treated with DDS and a silicone oil are preferable, and silica particles surface-treated with a silicone oil are particularly preferable because they have an excellent effect of reducing fogging in a high-temperature and high-humidity environment.

The silica particles before surface treatment (silica raw material) can be produced by a known method such as a dry method (gas phase method), a wet method, or a sol-gel method, and the gas phase method is preferable in that a solvent is not used. The gas phase method is a method of producing a silica raw material by vapor phase oxidation of a silicon halogen compound. For example, a silica raw material called dry (gas phase) silica or fumed silica is produced by a thermal decomposition oxidation reaction (basic reaction: SiCl₄+2H₂+O₂→SiO₂+4HCl) in an oxyhydrogen flame of a silicon tetrachloride gas.

Further, the silica raw material may be a composite of silica and another metal oxide obtained by using a metal halogen compound such as aluminum chloride or titanium chloride together with the silicon halogen compound in the above-mentioned production process.

The silica particles surface-treated with a silicone oil can be produced by, for example, a method of directly mixing a silica raw material treated with an organosilicon compound and a silicone oil using a mixer such as a Henschel mixer, a method of diluting a silica raw material with an appropriate solvent such as normal hexane and spraying a silicone oil onto the silica raw material followed by heat treatment, or a method of dissolving or dispersing a silicone oil in an appropriate solvent, adding and mixing a silica raw material, and removing the solvent.

The heat treatment after the spraying is preferably carried out in an atmosphere of an inert gas such as helium, nitrogen or argon for safety, and nitrogen gas is preferred in view of cost. The heat treatment temperature is preferably from 200 to 400° C.

Examples of the silicone oil include straight silicone oils such as dimethyl silicone oil, methylphenyl silicone oil, and methyl hydrogen silicone oil; and modified silicone oils such as epoxy-modified silicone oil, carboxyl-modified silicone oil, carbinol-modified silicone oil, methacryl-modified silicone oil, mercapto-modified silicone oil, phenol-modified silicone oil, single-end reactive-modified silicone oil, heterofunctional group-modified silicone oil, polyether-modified silicone oil, methylstyryl-modified silicone oil, alkyl-modified silicone oil, higher fatty acid ester-modified silicone oil, hydrophilic specially modified silicone oil, higher alkoxy-modified silicone oil, higher fatty acid-containing modified silicone oil, and fluorine-modified silicone oil; and one of these can be used alone, or two or more thereof can be used in combination.

Examples of the organosilicon compound include hexamethyldisilazane, trimethylsilane, trimethylethoxysilane, isobutyltrimethoxysilane, trimethylchlorosilane, dimethyldichlorosilane, methyltrichlorosilane, dimethylethoxysilane, dimethyldimethoxysilane, diphenyldiethoxysilane, and hexamethyldisiloxane; and these compounds can be used alone, or two or more thereof can be used in combination.

The silica particles treated with an silicone oil can be produced by, for example, a method described in JP 6849352 B, and desired fine particles can be obtained by changing the average primary particle size of the silica particles as a base material and the amount of silicone oil used.

The specific surface area of the silicone oil-treated silica particles as measured by the BET method is not particularly limited, and is about from 30 to 400 m²/g.

The silica particles can be produced by a known method as described above, and commercially available silica particles, for example, RX-200 (product name, available from Nippon Aerosil Co., Ltd., which is treated with hexamethyldisilazane) and R974 and R976S (product names, available from Nippon Aerosil Co., Ltd., which are treated with dimethoxydimethylsilane) as used in Examples can be used.

### Average Primary Particle Size

The silica particles preferably have an average primary particle size of from 7 to 16 nm. When the average primary particle size is in this range, the fluidity of the toner and a toner surface coverage can be uniformly ensured.

When the average primary particle size of the silica particles is less than 7 nm, the silica particles are embedded in the toner core particles and adhere to the toner core particles too strongly, and the spacer effect may not be maintained. On the other hand, when the average primary particle size of the silica particles exceeds 12 nm, the adhesiveness to the toner core particles becomes weak, and the covering effect may not be obtained. In addition, when the average primary particle size of the silica particles exceeds 16 nm, the amount of the silica particles to be externally added is increased in order to secure a coverage of the external additive, which is not preferable.

The average primary particle size of the silica particles is more preferably from 8 to 15 nm, and even more preferably from 9 to 13 nm.

The method for measuring the average primary particle size will be specifically described in Examples.

### External Addition Rate

An external addition rate of the external additive with respect to the toner core particles is preferably from 80 to 150 mass %.

When the external addition rate of the external additive is less than 80 mass %, it may be difficult to provide an effect of improving fluidity. On the other hand, when the external addition rate of the external additive is more than 150 mass %, fixability may be deteriorated.

The external addition rate of the external additive is more preferably from 85 to 140 mass %, and even more preferably from 90 to 130 mass %.

### Conductive Agent

In the toner of the disclosure, the toner core particles preferably further contain a conductive agent (conductive substance).

The introduction of the conductive agent increases the contact opportunity between the titanium oxide particles and the zinc oxide particles in the toner, and increases transfer of electrons between the two particles, the metal ions are more efficiently released, and the antibacterial performance can be improved.

### Material

The conductive agent is not particularly limited as long as it is a material that has conductivity, increases the contact opportunity between the titanium oxide particles and the zinc oxide particles in the toner, does not adversely affect the charging performance of the toner, and does not inhibit the effect of the toner of the disclosure, and examples thereof include carbon black and magnetite.

In the disclosure, one of the above conductive agents can be used alone or two or more thereof can be used in combination, and among the above conductive agents, carbon black is particularly preferable.

In the case of a black toner containing carbon black as a colorant, the carbon black is highly dispersed in the toner and is uniformly present in the interior of the toner particle and in the surface layer of the toner. Therefore, the carbon black effectively functions to increase the contact opportunity between the titanium oxide particles and the zinc oxide particles.

### Volume Average Particle Size

The conductive agent desirably has a particle diameter size equivalent to those of the titanium oxide particles and the zinc oxide particles, and preferably has a volume average particle size of from 10 to 1000 nm.

When the volume average particle size is less than 10 nm, the particle diameter is too small, and it becomes difficult to highly disperse the conductive agent in the toner. On the other hand, when the volume average particle size exceeds 1000 nm, it is too large with respect to the toner particle diameter and deviation becomes large.

The volume average particle size is more preferably from 15 to 800 nm, and particularly preferably from 20 to 500 nm.

### Internal Addition Rate

In the toner of the disclosure, the conductive agent is preferably contained in the toner core particles at an internal addition rate of from 1 to 20 mass %.

When the internal addition rate is less than 1 mass %, an effect due to increase in contact opportunity between the titanium oxide particles and the zinc oxide in the toner may not be sufficiently exhibited. On the other hand, when the internal addition rate is more than 20 mass %, electrical conduction occurs (percolation) in the toner core particles, which may adversely affect the charging performance of the toner. The internal addition rate is more preferably from 2 to 15 mass %, and particularly preferably from 4 to 10 mass %.

The amount of the conductive agent is about from 1 to 25 parts by mass with respect to 100 parts by mass of the binder resin described below, depending on content proportions of the other components contained in the toner core particles.

### (1) Toner

The toner of the disclosure includes at least toner core particles and an external additive component externally added to the surface of the toner core particle.

### Toner Core Particles

The toner core particles contain at least a binder resin, a colorant, and a release agent, and further contain the above-described conductive agent, charging control agent, and the like as necessary.

### Binder Resin

As the binder resin, a resin commonly used in the art can be used, and examples thereof include polyester-based resin, polystyrene-based resins like styrene-acrylic resins, (meth)acrylic ester-based resins, polyolefin-based resins, polyurethane-based resins, and epoxy-based resins. One of these can be used alone, or two or more thereof can be used in combination. Among them, a polystyrene-based resin and a polyester-based resin are preferable, and a polyester-based resin is particularly preferable.

The polystyrene-based resin is preferably a styrene-acrylic resin (styrene-acrylic copolymer resin). Examples of a styrene monomer usable as a resin raw material include styrene derivatives such as styrene, o-methylstyrene, m-methylstyrene, p-methylstyrene, α-methylstyrene, p-ethylstyrene and 2,4-dimethylstyrene, and examples of an acrylic monomer include acrylic acid derivatives and methacrylic acid derivatives such as acrylic acid, methyl acrylate, ethyl acrylate, n-butyl acrylate, isobutyl acrylate, propyl acrylate, octyl acrylate, 2-chloroethyl acrylate, phenyl acrylate, methacrylic acid, methyl methacrylate, ethyl methacrylate, propyl methacrylate, n-butyl methacrylate, isobutyl methacrylate, n-octyl methacrylate, 2-ethylhexyl methacrylate, phenyl methacrylate and dimethylamino methacrylate ester.

Further, as the resin raw material, a vinyl-based monomer such as maleic anhydride, maleic acid monomethyl ester, maleic acid monoethyl ester, maleic acid monophenyl ester, maleic acid monoallyl ester or divinylbenzene may be used.

The polyester-based resin is usually produced by subjecting one or more selected from the group consisting of dihydric alcohol components and trihydric or higher polyhydric alcohol components and one or more selected from the group consisting of divalent carboxylic acids and trivalent or higher polyvalent carboxylic acids to a condensation polymerization reaction, esterification, or transesterification reaction by a known method.

The conditions in the condensation polymerization reaction are to be appropriately set according to the reactivity of the monomer components, and the reaction is to be terminated when the polymer has suitable physical properties. For example, the reaction temperature is approximately from 170 to 250° C., and the reaction pressure is approximately from 5 mmHg to normal pressure.

Examples of the dihydric alcohol component include alkylene oxide adducts of bisphenol A, such as poly(oxypropylene)(2.2)-2,2-bis(4-hydroxyphenyl)propane, poly(oxypropylene)(3.3)-2,2-bis(4-hydroxyphenyl)propane, poly(oxypropylene)(2.0)-2,2-bis(4-hydroxyphenyl)propane, poly(oxypropylene)(2.0)-poly(oxyethylene)(2.0)-2,2-bis(4-hydroxyphenyl)propane, and poly(oxypropylene)(6)-2,2-bis(4-hydroxyphenyl)propane; diols, such as ethylene glycol, diethylene glycol, triethylene glycol, 1,2-propylene glycol, 1,3-propylene glycol, 1,4-butanediol, neopentyl glycol, 1,4-butenediol, 1,5-pentanediol, 1,6-hexanediol, 1,4-cyclohexanedimethanol, dipropylene glycol, polyethylene glycol, polypropylene glycol, and polytetramethylene glycol; bisphenol A; propylene adducts of bisphenol A; ethylene adducts of bisphenol A; and hydrogenated bisphenol A.

Examples of the trihydric or higher polyhydric alcohol component include sorbitol, 1,2,3,6-hexanetetrol, 1,4-sorbitan, pentaerythritol, dipentaerythritol, tripentaerythritol, sucrose (cane sugar), 1,2,4-butanetriol, 1,2,5-pentanetriol, glycerol, 2-methylpropanetriol, 2-methyl-1,2,4-butanetriol, trimethylolethane, trimethylolpropane, and 1,3,5-trihydroxymethylbenzene.

In the toner of the disclosure, one of the dihydric alcohol components and trihydric or higher polyhydric alcohol components can be used alone, or two or more thereof can be used in combination.

Examples of the divalent carboxylic acid include maleic acid, fumaric acid, citraconic acid, itaconic acid, glutaconic acid, phthalic acid, isophthalic acid, terephthalic acid, cyclohexanedicarboxylic acid, succinic acid, adipic acid, sebacic acid, azelaic acid, malonic acid, n-dodecenylsuccinic acid, n-dodecylsuccinic acid, n-octylsuccinic acid, isooctenylsuccinic acid, isooctylsuccinic acid, and acid anhydrides or lower alkyl esters of these.

Examples of the trivalent or higher polycarboxylic acid include 1,2,4-benzenetricarboxylic acid, 1,2,5-benzenetricarboxylic acid, 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxyl-2-methyl-2-methylenecarboxypropane, 1,2,4-cyclohexanetricarboxylic acid, tetra(methylenecarboxyl)methane, 1,2,7,8-octanetetracarboxylic acid, pyromellitic acid, Empol trimer acid, and acid anhydrides or lower alkyl esters of these. In the toner of the disclosure, one of the dihydric carboxylic acids and trihydric or higher carboxylic acids can be used alone, or two or more thereof can be used in combination.

The polyester-based resin preferably has a mass average molecular weight in a range of from 3000 to 50000. When the mass average molecular weight is less than 3000, the releasing property on the high temperature side of the fixable region (non-offset region) may be deteriorated. On the other hand, when the mass average molecular weight exceeds 50000, low-temperature fixability may be deteriorated.

The polyester-based resin preferably has an acid value in a range from 5 to 30 mgKOH/g. When the acid value is less than 5 mgKOH/g, the charging characteristics of the polyester-based resin decrease and the charging control agent becomes difficult to disperse in the polyester-based resin, which may adversely affect the charge rising property and the charge stability during continuous use. On the other hand, when the acid value exceeds 30 mgKOH/g, the hygroscopicity may increase and the chargeability may become unstable.

### Colorant

As the colorant, organic and inorganic pigments and dyes of various types and colors commonly used in the art can be used, and examples thereof include black, white, yellow, orange, red, purple, blue, and green colorants.

Examples of the black colorant include carbon black, copper oxide, manganese dioxide, aniline black, activated carbon, nonmagnetic ferrite, magnetic ferrite, and magnetite.

The carbon black is classified into channel black, roller black, disk black, gas furnace black, oil furnace black, thermal black, acetylene black, and the like according to the production method thereof, and an appropriate carbon black can be appropriately selected from these according to the design characteristics of the toner to be obtained. Examples of the white colorant include zinc oxide, titanium oxide, antimony white, and zinc sulfide.

Examples of the yellow colorant include chrome yellow, zinc yellow, cadmium yellow, yellow iron oxide, mineral fast yellow, nickel titanium yellow, navel yellow, naphthol yellow S, Hansa yellow G, Hansa yellow 10G, benzidine yellow G, benzidine yellow GR, quinoline yellow lake, Permanent Yellow NCG, tartrazine lake, C.I. Pigment Yellow 12, C.I. Pigment Yellow 13, C.I. Pigment Yellow 14, C.I. Pigment Yellow 15, C.I. Pigment Yellow 17, C.I. Pigment Yellow 74, C.I. Pigment Yellow 93, C.I. Pigment Yellow 94, C.I. Pigment Yellow 138, and C.I. Pigment Yellow 185.

Examples of the orange colorant include red chrome yellow, molybdenum orange, Permanent Orange GTR, pyrazolone orange, vulcan orange, Indanthrene Brilliant Orange RK, benzidine orange G, Indanthrene Brilliant Orange GK, C.I. Pigment Orange 31, and C.I. Pigment Orange 43.

Examples of the red colorant include red iron oxide, cadmium red, red lead, mercury sulfide, cadmium, Permanent Red 4R, Lithol Red, pyrazolone red, watching red, calcium salts, Lake Red C, Lake Red D, Brilliant Carmine 6B, eosin lake, Rhodamine Lake B, alizarin lake, Brilliant Carmine 3B, C.I. Pigment Red 2, C.I. Pigment Red 3, C.I. Pigment Red 5, C.I. Pigment Red 6, C.I. Pigment Red 7, C.I. Pigment Red 15, C.I. Pigment Red 16, C.I. Pigment Red 48:1, C.I. Pigment Red 53:1, C.I. Pigment Red 57:1, C.I. Pigment Red 122, C.I. Pigment Red 123, C.I. Pigment Red 139, C.I. Pigment Red 144, C.I. Pigment Red 149, C.I. Pigment Red 166, C.I. Pigment Red 177, C.I. Pigment Red 178, C.I. Pigment Red 222, and C.I. Pigment Red 269.

Examples of the violet colorant include manganese violet, fast violet B, and methyl violet lake.

Examples of the blue colorant include iron blue, cobalt blue, alkali blue lake, victoria blue lake, phthalocyanine blue, metal-free phthalocyanine blue, partially chlorinated phthalocyanine blue, Fast Sky Blue, Indanthrene Blue BC, C.I. Pigment Blue 15, C.I. Pigment Blue 15:2, C.I. Pigment Blue 15:3, C.I. Pigment Blue 16, and C.I. Pigment Blue 60.

Examples of the green colorant include chrome green, chromium oxide, Pigment Green B, mica light green lake, Final Yellow Green G, and C.I. Pigment Green 7.

In the disclosure, one of the above colorants can be used individually, or two in combination, and the combination may have different colors or the same color. In addition, two or more colorants may be used in the form of composite particles. The composite particles can be produced for example, by adding appropriate amounts of water, a lower alcohol, and/or the like to two or more colorants, granulating the mixture with a common granulator, such as a high-speed mill, and drying the granulated mixture.

Furthermore, to uniformly disperse the colorant in the binder resin, the colorant may be used in the form of masterbatch.

The composite particles and masterbatch are mixed into a toner composition during dry mixing.

The colorant is not particularly limited, but is preferably contained in the toner core particles at an internal addition rate of from 2 to 10 mass %.

When the internal addition rate of the colorant is less than 2 mass %, sufficient coloring power may not be obtained and the image density may be too low. On the other hand, when the internal addition rate of the colorant is more than 10 mass %, the charging performance of the toner may be affected or the toner melt viscosity in the vicinity of the colorant may increase due to the filler effect, depending on the colorant, thereby making it difficult to uniformly disperse the colorant in the toner, which may easily cause uneven distribution of the colorant.

The internal addition rate is more preferably from 2.5 to 8 mass %, and even more preferably from 3 to 7 mass %.

The amount of the colorant is about from 2 to 15 parts by mass with respect to 100 parts by mass of the binder resin, depending on the content proportions of the other components contained in the toner core particles.

### Release Agent

As the release agent, a release agent commonly used in the art can be used, and examples thereof include petroleum-based waxes, such as paraffin waxes, microcrystalline waxes, and their derivatives; hydrocarbon-based synthetic waxes, such as Fischer-Tropsch waxes, polyolefin waxes (such as polyethylene waxes and polypropylene waxes), low molecular weight polypropylene waxes, and polyolefin-based polymer waxes (such as low molecular weight polyethylene waxes), and their derivatives; plant-based waxes, such as carnauba waxes, rice waxes, candelilla waxes, and their derivatives, and Japan waxes; animal waxes, such as beeswaxes and spermaceti waxes; oil and/or fat-based synthetic waxes, such as fatty acid amides and phenolic fatty acid esters; long-chain carboxylic acids and their derivatives; long-chain alcohols and their derivatives; silicone-based polymers; and higher fatty acids. The above derivatives include oxides; block copolymers of vinyl monomers and waxes, and graft-modified products of vinyl monomers and waxes.

In the disclosure, one of the above release agents can be used alone, or two or more thereof can be used in combination.

The release agent is not particularly limited, but is preferably contained in the toner core particles at an internal addition rate of from 1 to 10 mass %.

When the internal addition rate of the release agent is less than 1 mass %, the release agent cannot sufficiently ooze out to the melted toner surface when the toner is fixed to a printed matter, and the toner is hardly peeled off from a fixing roller, which may cause micro-offset particularly at a high temperature. On the other hand, when the internal addition rate is more than 10 mass %, the amount of the release agent present in the vicinity of the toner surface increases, and the release agent starts to melt and bleed out in an environment exceeding the melting point of the release agent or the glass transition point of the toner, which may cause aggregation of the toners. The internal addition rate is more preferably from 2 to 9 mass %, and more preferably from 3 to 8 mass %.

The amount of the release agent is about from 1 to 13 parts by mass with respect to 100 parts by mass of the binder resin, depending on the content proportions of the other components contained in the toner core particles.

### Conductive Agent

The conductive agent is as described above.

### Charging Control Agent (Charge Control Agent)

The toner core particles of the disclosure may contain a charging control agent, if necessary. Examples of the charging control agent include charging control agents for positive charge control and negative charge control commonly used in the art. Examples of the charging control agent for positive charge control include nigrosine dyes and derivatives thereof, basic dyes, quaternary ammonium salts, quaternary phosphonium salts, aminopyrines, pyrimidine compounds, polynuclear polyamino compounds, aminosilanes, triphenylmethane derivatives, guanidine salts, and amidine salts.

Examples of the charging control agent for negative charge control include oil-soluble dyes, such as oil black and Spilon Black; metal-containing azo compounds, azo complex dyes, metal salts of naphthenic acid, metal complexes and metal salts of salicylic acid and its derivatives (examples of the metal include chromium, zinc, or zirconium), boron compounds, fatty acid soaps, long-chain alkyl carboxylate salts, and resin acid soaps.

The charging control agent is not particularly limited, but is preferably contained in the toner core particles at an internal addition rate of from 0.1 to 5 mass %.

When the internal addition rate of the charging control agent is less than 0.1 mass %, the addition amount of the charging control agent is too small, which has no influence on the charging performance of the toner. On the other hand, when the internal addition rate is more than 5 mass %, the addition amount of the charging control agent is too large, which may adversely affect the charging performance of the toner.

The internal addition rate is more preferably from 0.2 to 4 mass %, and even more preferably from 0.5 to 3 mass %.

The amount of the charging control agent is about from 0.1 to 8 parts by mass with respect to 100 parts by mass of the binder resin, depending on the content proportions of the other components contained in the toner core particles.

### Volume Average Particle Size of Toner Core Particles

The volume average particle size of the toner core particles is not particularly limited and may be appropriately set depending on the intended purpose. The toner core particles preferably have a volume average particle size of from 4 to 10 μm.

When the volume average particle size is less than 4 μm, the particles are too small, making it difficult to arrange the toner at a desired position by electrostatic force, which may cause scattering or fogging. On the other hand, if the volume average particle size exceeds 10 μm, the particles may be too large and adversely affect the resolution of fine lines and images.

The volume average particle size is more preferably from 5 to 9 μm, and even more preferably from 5.5 to 7 μm.

A coefficient of variation of the volume average particle size is not particularly limited, but is about from 18 to 28%.

Methods for measuring the volume average particle size of the toner core particles and the coefficient of variation thereof will be described in Examples.

### (2) Method for Producing Toner

The toner of the disclosure can be produced by a known method using a known apparatus commonly used in the art. In the production process, toner core particles are produced, and an external additive is externally added to the obtained toner core particles to produce a toner. Examples of the method for producing the toner core particles include a dry method such as a pulverization method and a wet method such as a suspension polymerization method, an emulsion aggregation method, a dispersion polymerization method, a dissolution suspension method, and a melt emulsification method. The dry method is preferable in terms of a smaller number of steps and a lower equipment cost than the wet method, and the pulverization method is particularly preferable. Hereinafter, a method for producing a toner by the pulverization method will be described for each step.

Conditions in each of the steps are to be appropriately set according to the target material and desired physical properties.

### Kneading (Melt-Kneading) Step S1

In a kneading step S1, for example, toner raw materials including a binder resin, a colorant, a release agent, and optionally a charging control agent are dry-mixed in a mixer, and then kneaded in a kneader to obtain a melt-kneaded product. The kneading is performed by heating to a temperature equal to or higher than the softening point and lower than the thermal decomposition temperature of the binder resin. Thus, the binder resin is melted or softened, and other toner raw materials can be dispersed in the binder resin. A specific heating temperature during kneading is, for example, preferably from 80 to 200° C., and more preferably from 100 to 180° C.

For the mixing, a known apparatus commonly used in the art, for example, a Henschel type (airflow mixing) mixing apparatus such as Henschel Mixer (product name, available from Mitsui Mining Corporation (now NIPPON COKE & ENGINEERING CO., LTD.)), Super Mixer (product name, available from Kawata Mfg Co., Ltd.), or Mechanomill (product name, available from Okada Seiko Co., Ltd.), or a mixing apparatus such as Ong Mill (product name, available from Hosokawa Micron Corporation), Hybridization System (product name, available from NARA MACHINERY CO., LTD.), or Cosmo System (product name, available from Kawasaki Heavy Industries, Ltd.) can be used.

For the melt-kneading, a known apparatus commonly used in the art, for example, a general kneader such as a twin-screw extruder, a three roll mill, or Labo Plastmill can be used. Examples of such a kneader include single-screw and twin-screw extruders such as TEM-100B (product name, available from Toshiba Machine Co., Ltd.), and PCM-65/87 and PCM-30 (product names, available from Ikegai Co., Ltd.); and open-roll type kneaders such as Kneadex (product name, available from Mitsui Mining Corporation). Among them, an open-roll type kneader is preferable, and the kneading step may be performed using a plurality of kneaders.

### Pulverization (Cooling Pulverization) Step S2

In a pulverization step S2, the melt-kneaded product obtained in the kneading step S1 is cooled and solidified, the solidified product is coarsely pulverized to obtain a coarsely pulverized product, and the obtained coarsely pulverized product is further finely pulverized to obtain a finely pulverized product.

For cooling, a known apparatus commonly used in the art, for example a cooling belt, can be used.

For the coarse pulverization, a known apparatus commonly used in the art, for example, a speed mill, hammer mill, or cutter mill having a screen can be used.

For the fine pulverization, a known apparatus commonly used in the art can be used, for example, a jet type pulverizer which performs pulverization by using a supersonic jet stream, or an impact type pulverizer which performs pulverization by introducing a solidified material into a space formed between a rotator (rotor) rotating at a high speed and a stator (liner).

A group of finely pulverized particles having a desired volume average particle size obtained in the pulverization step S2 may be collected as toner core particles without performing the following classification step S3.

### Classification Step S3

In the classification step S3, the finely pulverized product obtained in the pulverization step S2 is classified using a classifier to obtain toner core particles having a desired volume average particle size.

For the classification, a known apparatus commonly used in the art, for example, a classifier capable of removing excessively pulverized toner particles by centrifugal force and wind force, such as a rotary air classifier, can be used.

### External Addition Step S4

In an external addition step S4, the toner core particles obtained in the classification step S3 and the external additive described in the section External Additive are mixed using a mixer to cause the external additive to adhere to the surfaces of the toner core particles, thereby obtaining a toner (toner with external additives).

For the mixing, a known apparatus commonly used in the art, for example, the mixing apparatus described for the kneading step S1 can be used.

The toner of the disclosure may be used as a one-component developer as it is, or may be mixed with a carrier and used as a two-component developer. When the toner is used as a one-component developer, a blade and a fur brush are used, and the toner is frictionally charged by a developing sleeve and adhered to the sleeve, whereby the toner is conveyed to form an image.

### (3) Two-Component Developer

A two-component developer of the disclosure contains the toner of the disclosure and a carrier.

### Carrier

As the carrier, a carrier commonly used in the art can be used, and examples thereof include single or composite ferrite particles composed of iron, copper, zinc, nickel, cobalt, manganese, chromium, and the like; resin-covered carriers produced by surface-covering carrier core particles with a known covering substance; and resin-dispersed carriers in which particles having magnetism are dispersed in a resin.

As the covering substance, a substance commonly used in the art can be used, and examples thereof include polytetrafluoroethylene, monochlorotrifluoroethylene polymers, polyvinylidene fluoride, silicone resins, polyester-based resins, metallic compounds of ditertiary butylsalicylic acid, styrene-based resins, acrylic resins, polyamides, polyvinyl butyral, nigrosine, aminoacrylate resins, basic dyes, lakes of basic dyes, fine silica powder, and fine alumina powder.

The resin used in the resin-dispersed carrier is not particularly limited, and examples thereof include a styrene-acrylic resin, a polyester-based resin, a fluorine-based resin, and a phenol resin.

The covering substance and the resin used in the resin-dispersed carrier can be used alone, or two or more thereof can be used in combination. They are preferably selected according to the toner components.

The shape of the carrier is not particularly limited, but is preferably spherical and flat. In addition, an average particle diameter of the carrier is not particularly limited, but is preferably from 30 to 80 μm, and more preferably from 40 to 60 μm in consideration of high image quality.

A volume resistivity of the carrier is a value obtained from a current value when particles of the carrier are placed in a vessel having a cross-sectional area of 0.50 cm² and tapped, a load of 1 kg/cm² is applied to the particles packed in the vessel, and a voltage generating an electric field of 1000 V/cm is applied between the load and a bottom electrode. When the volume resistivity is low, the carrier is charged when a bias voltage is applied to the developing sleeve, and the carrier particles easily adhere to a photoreceptor. In addition, breakdown of the bias voltage is likely to occur. The volume resistivity of the carrier is preferably from 1.0×10⁹ to 1.0×10¹³ (Ω·cm).

A magnetization intensity (maximum magnetization) of the carrier is preferably from 10 to 60 emu/g, and more preferably from 15 to 40 emu/g. Under a general magnetic flux density condition of a developing roller, when the magnetization intensity is less than 10 emu/g, a magnetic constraining force does not act, and there is a possibility that carriers may be scattered. On the other hand, when the magnetization intensity exceeds 60 emu/g, naps of the carrier become too high, making it difficult to maintain the non-contact state between an image bearing member and the toner in non-contact development, and there is a possibility that sweeping marks are likely to appear in a toner image in contact development.

Blending proportions of the toner and the carrier in the two-component developer are not particularly limited and may be appropriately selected depending on the types of the toner and the carrier. For example, when the toner is mixed with a resin-covered carrier (density: from 5 to 8 g/cm²), the toner may be contained in an amount of from 2 to 30 mass %, preferably from 2 to 20 mass % of a total amount of the developer. A coverage of the carrier with the toner is preferably from 40 to 80 mass %.

### (4) Application of Toner

The toner of the disclosure can be fixed on a recording medium such as paper or resin to produce a printed matter having antibacterial properties.

In addition, in order to maximally utilize the antibacterial performance of the toner of the disclosure, it is preferable to perform solid printing on the entire surface of the recording medium to form an antibacterial sheet (film) (antibacterial coating).

When compatibility between a resin material of the binder resin constituting the toner of the disclosure and a resin material constituting the recording medium (resin sheet) is poor, for example, when a polyester resin (PES) and a polyethylene terephthalate resin (PET) are used in combination, the toner of the disclosure may be fixed after the surface of the recording medium is roughened in advance. Alternatively, it is also effective to enhance compatibility between the toner and the recording medium (resin sheet) by mixing a polyethylene terephthalate resin (PET) with the main resin of the toner.

### EXAMPLES

Hereinafter, the toner of the disclosure and the two-component developer containing the toner will be specifically described with reference to Examples and Comparative Examples, but the disclosure is not limited to these Examples as long as the gist thereof is not exceeded.

In Examples and Comparative Examples, physical properties of the materials used, the toners obtained, and the two-component developers containing the toners were measured by the following methods.

### (1) Volume Average Particle Size of Toner Core Particles and Coefficient of Variation Thereof

To 50 ml of an electrolytic solution (available from Beckman Coulter, K.K., trade name: ISOTON-II), 20 mg of a sample and 1 ml of a sodium alkyl ether sulfate are added. The mixture is treated by dispersion at a frequency of 20 kHz for 3 minutes using an ultrasonic disperser (available from SMT Co., Ltd., model: UH-50), and a measurement sample is prepared. The resulting measurement sample is measured using a particle size distribution measuring device (available from Beckman Coulter, K.K., model: Multisizer 4e) under conditions of an aperture size of 100 μm and the number of measurement particles of 50000 counts, and the volume average particle size and coefficient of variation thereof are determined from a volume particle size distribution of the sample particles.

### (2) Average Primary Particle Sizes of Titanium Oxide Particles and Zinc Oxide Particles

SEM images (magnified 10000 times) of titanium oxide particles and zinc oxide particles are obtained in 10 different fields of view, 20 particles are randomly extracted for each, and the long axis and the short axis are calculated for each of the particles by image analysis. An average value of the long axis and the short axis is defined as the average primary particle size.

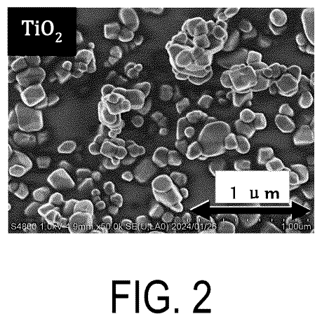

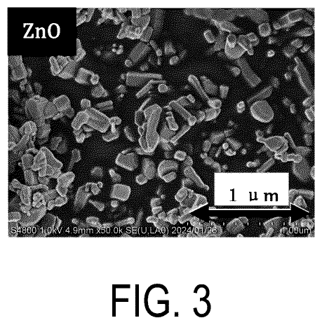

FIGS. 2 and 3 are SEM images of titanium oxide particles and zinc oxide particles used in Example 1, respectively.

### (3) Hydrophobization Rates of Titanium Oxide Particles and Zinc Oxide Particles

Titanium oxide particles or zinc oxide particles (1.0 g) as a measurement sample and 100 mL of ion-exchanged water W are put in a beaker having a volume of 500 mL, and the mixture is stirred with a magnetic stirrer. Next, methanol is added dropwise from the top of the beaker using a burette, and an amount M (mL) of methanol added dropwise until all of the measurement sample on the water surface is dispersed in the solution and disappears is measured. From the obtained results, the hydrophobization rate is calculated from the following equation.

$$Hydrophobization rate ( \% ) = M / ( M + W ) \times 100$$

### (4) Adhesion Strengths of Titanium Oxide Particles and Zinc Oxide Particles

(a) The toner (2.0 g) is added to 40 ml of a 0.2 mass % aqueous solution of triton (polyoxyethylene octylphenyl ether), and the mixture is stirred with a stirrer for 1 minute to infiltrate the toner.
(b) The resulting aqueous solution is irradiated with an ultrasonic wave with an output of 40 μA for 4 minutes using a homogenizer (available from Nissei Co., Ltd., model: US-300T) to detach the external additive in the toner.
(c) Thereafter, the aqueous solution is allowed to stand for 3 hours, and the toner and the detached external additive are separated.
(d) After removal of the supernatant, about 50 ml of pure water is added to the precipitate, and the mixture is stirred for 5 minutes with stirrer.
(e) The mixture is suction-filtered using a membrane filter with a pore size of 1 μm (available from Advantec Co., Ltd.).
(f) The toner remaining on the filter is vacuum-dried for 24 hours in a desiccator containing silica gel.
(g) A X-ray fluorescence analyzer (available from Rigaku Corporation, model: ZSX Primus II) is used to analyze the intensities of elements (Ti, Zn) in the external additive in 1 g of the toner before and after the ultrasonic treatment under the following conditions. The toner (1 g) is pelletized to obtain a measurement sample.

Target of X-ray source: Rh

Voltage and current applied to X-ray source: 40 kV and 50 mA

Dispersive crystal of optical system: LiF (target: Ti) or pentaerythritol (PET, target: Zn)

Detector: scintillation counter and photocounter

Scanning of spectrometer: skip scanning method

PHA range: from 100 to 300, 0.05 degrees per step
(h) The adhesion strength of the external additive is calculated by the following equation.

$$Adhesion strength ( \% ) of titanium oxide = [ ( X - ray flourescence intensity of T i element after treatment ) / ( X - ray flourescence intensity of T i element before treatment ) ] \times 100$$

$$Adhesion strength ( \% ) of zinc oxide = [ ( X - ray flourescence intensity of Z n element after treatment ) / ( X - ray flourescence intensity of Z n element before treatment ) ] \times 100.$$

### (5) Average Primary Particle Size (μm) of Silica Particles

A dynamic light scattering particle size distribution measuring apparatus (available from Nikkiso Co., Ltd., model: Nanotrac wave series), the average primary particle size of the silica particles is measured twice, and an average value thereof is defined as the average primary particle size (μm) of the silica particles.

As measurement conditions, the measurement time is 30 seconds, the sample particle refractive index is 1.49, the dispersion medium is water, and the dispersion medium refractive index is 1.33. The volume particle size distribution of the measurement sample is measured, and the particle size at which a cumulative volume from the small particle size side in a cumulative volume distribution reaches 50% is calculated as the average primary particle size (μm) of the silica particles from the measurement result.

Fine titanium oxide particles and fine zinc oxide particles having desired average primary particle sizes were prepared in advance, and then hydrophobized fine titanium oxide particles and hydrophobized fine zinc oxide particles were prepared by hydrophobization treatment to give desired hydrophobization rates.

### (Production Example T1) Preparation of Fine Titanium Oxide Particles 1

(1) To 150 g of barium titanate (available from FUJIFILM Wako Pure Chemical Corporation), 900 mL of a 13.3 Normal (13.3 N) aqueous hydrochloric acid solution was added, and the mixture was stirred for 96 hours. Thereafter, an undissolved portion was filtered and separated.
(2) The solution obtained by filtering the undissolved portion was diluted 5 times with pure water, and heated to 80° C., and reacted for 12 hours while maintaining the temperature, thereby obtaining a milky white liquid in which titanium oxide was dispersed.
(3) Aqueous ammonia was added to the obtained titanium oxide dispersion to adjust the pH to from 4.5 to 6.0, and then the precipitated titanium oxide was separated by filtration.
(4) The separated titanium oxide was washed several times with pure water and then dried at 120° C., thereby obtaining fine titanium oxide particles 1 having an average primary particle size of 87.6 nm.

### (Production Example T2) Preparation of Fine Titanium Oxide Particles 2

Fine titanium oxide particles 2 having an average primary particle size of 69.5 nm were obtained in the same manner as in Production Example T1 except that the concentration of the aqueous hydrochloric acid solution was set to 13.0 Normal (13.0 N).

### (Production Example T3) Preparation of Fine Titanium Oxide Particles 3

Fine titanium oxide particles 3 having an average primary particle size of 76.1 nm were obtained in the same manner as in Production Example T1 except that the concentration of the aqueous hydrochloric acid solution was set to 13.1 Normal (13.1 N).

### (Production Example T4) Preparation of Fine Titanium Oxide Particles 4

Fine titanium oxide particles 4 having an average primary particle size of 81.4 nm were obtained in the same manner as in Production Example T1 except that the concentration of the aqueous hydrochloric acid solution was set to 13.2 Normal (13.2 N).

### (Production Example T5) Preparation of Fine Titanium Oxide Particles 5

Fine titanium oxide particles 5 having an average primary particle size of 192.4 nm were obtained in the same manner as in Production Example T1 except that the concentration of the aqueous hydrochloric acid solution was set to 14.5 Normal (14.5 N).

### (Production Example T6) Preparation of Fine Titanium Oxide Particles 6

Fine titanium oxide particles 6 having an average primary particle size of 211.4 nm were obtained in the same manner as in Production Example T1 except that the concentration of the aqueous hydrochloric acid solution was set to 14.6 Normal (14.6 N).

### (Production Example TH1) Preparation of Hydrophobized Fine Titanium Oxide Particles 1

(1) The fine titanium oxide particles 1 (average particle size: 87.6 nm)(1000 g) were placed in a mixer having a volume of 20 L (heater Henschel mixer, available from NIPPON COKE & ENGINEERING CO., LTD., model: MH-20), and a mixed solution of 2800 g of methylhydrogenpolysiloxane (product name: KF9901, available from Shin-Etsu Chemical Co., Ltd., hydrogen dimethicone) and 100 g of isopropyl alcohol (IPA) was added dropwise under low speed stirring using N₂ gas as a seal air.
(2) After the dropwise addition, the mixture was stirred at a low speed for 10 minutes, and then the mixed powder was taken out, dried at 40° C. for 3 hours by a hot air dryer, and further dried at 130° C. for 5 hours.
(3) The obtained powder was pulverized with a pulverizer (V Turbo available from FREUND-TURBO CORPORATION), thereby obtaining hydrophobized fine titanium oxide particles 1 having a hydrophobization rate of 67%.

### (Production Example TH2) Preparation of Hydrophobized Fine Titanium Oxide Particles 2

Hydrophobized fine titanium oxide particles 2 having a hydrophobization rate of 70% were obtained in the same manner as in Production Example TH1 except that the fine titanium oxide particles 1 were changed to the fine titanium oxide particles 2 and that the amount of methyl hydrogen polysiloxane was changed from 2800 g to 3700 g.

### (Production Example TH3) Preparation of Hydrophobized Fine Titanium Oxide Particles 3

Hydrophobized fine titanium oxide particles 3 having a hydrophobization rate of 79% were obtained in the same manner as in Production Example TH1 except that the fine titanium oxide particles 1 were changed to the fine titanium oxide particles 3 and that the amount of methyl hydrogen polysiloxane was changed from 2800 g to 3800 g.

### (Production Example TH4) Preparation of Hydrophobized Fine Titanium Oxide Particles 4

Hydrophobized fine titanium oxide particles 4 having a hydrophobization rate of 90% were obtained in the same manner as in Production Example TH1 except that the fine titanium oxide particles 1 were changed to the fine titanium oxide particles 4 and that the amount of methyl hydrogen polysiloxane was changed from 2800 g to 4050 g.

### (Production Example TH5) Preparation of Hydrophobized Fine Titanium Oxide Particles 5

Hydrophobized fine titanium oxide particles 5 having a hydrophobization rate of 35% were obtained in the same manner as in Production Example TH1 except that the amount of methyl hydrogen polysiloxane was changed from 2800 g to 1460 g.

### (Production Example TH6) Preparation of Hydrophobized Fine Titanium Oxide Particles 6

Hydrophobized fine titanium oxide particles 6 having a hydrophobization rate of 61% were obtained in the same manner as in Production Example TH1 except that the fine titanium oxide particles 1 were changed to the fine titanium oxide particles 5 and that the amount of methyl hydrogen polysiloxane was changed from 2800 g to 1160 g.

### (Production Example TH7) Preparation of Hydrophobized Fine Titanium Oxide Particles 7

Hydrophobized fine titanium oxide particles 7 having a hydrophobization rate of 65% were obtained in the same manner as in Production Example TH1 except that the fine titanium oxide particles 1 were changed to the fine titanium oxide particles 6 and that the amount of methyl hydrogen polysiloxane was changed from 2800 g to 1140 g.

### (Production Example Z1) Preparation of Fine Zinc Oxide Particles 1

(1) Zinc oxide (primary particle size: 20 nm, product name: FINEX-50, available from Sakai Chemical Industry Co., Ltd.) (100 g) as seed particles was re-dissolved in 1500 ml of an aqueous zinc acetate solution in which 154.22 g of zinc acetate dihydrate (available from FUJIFILM Wako Pure Chemical Corporation) was dissolved in pure water, thereby preparing a slurry.
(2) The obtained slurry was increased in temperature to 70° C. over 45 minutes while stirring, and continuously stirred at 70° C. for 3 hours for aging.
(3) The obtained aqueous zinc acetate solution was filtered and washed with pure water, thereby obtaining a solid.
(4) The obtained solid was dispersed in 3 L of pure water, and the mixture was increased in temperature to 70° C. over 45 minutes while stirring again, and heated and washed for 30 minutes while stirring at 70° C.
(5) The obtained aqueous zinc acetate solution was filtered, washed with pure water, and dried at 110° C. for 12 hours, thereby obtaining fine zinc oxide particles 1 having an average primary particle size of 102.9 nm.

### (Production Example Z2) Preparation of Fine Zinc Oxide Particles 2

Fine zinc oxide particles 2 having an average primary particle size of 78.6 nm were obtained in the same manner as in Production Example Z1 except that the amount of zinc oxide dihydrate was changed from 154.22 g to 123.54 g.

### (Production Example Z3) Preparation of Fine Zinc Oxide Particles 3

Fine zinc oxide particles 3 having an average primary particle size of 88.2 nm were obtained in the same manner as in Production Example Z1 except that the amount of zinc oxide dihydrate was changed from 154.22 g to 135.66 g.

### (Production Example Z4) Preparation of Fine Zinc Oxide Particles 4

Fine zinc oxide particles 4 having an average primary particle size of 291.1 nm were obtained in the same manner as in Production Example Z1 except that the amount of zinc oxide dihydrate was changed from 154.22 g to 391.87 g.

### (Production Example Z5) Preparation of Fine Zinc Oxide Particles 5

Fine zinc oxide particles 5 having an average primary particle size of 323.3 nm were obtained in the same manner as in Production Example Z1 except that the amount of zinc oxide dihydrate was changed from 154.22 g to 432.53 g.

### (Production Example ZH1) Preparation of Hydrophobized Fine Zinc Oxide Particles 1

(1) The fine zinc oxide particles 1 (average particle size: 102.9 nm)(3000 g) were placed in a mixer having a volume of 20 L (heater Henschel mixer, available from NIPPON COKE & ENGINEERING CO., LTD., model: MH-20), and a mixed solution of 910 g of aminopropyltriethoxysilane (product name: KBE903, available from Shin-Etsu Chemical Co., Ltd.) and 100 g of isopropyl alcohol (IPA) was added dropwise under low speed stirring using N₂ gas as a seal air.
(2) After the dropwise addition, the mixture was stirred at a low speed for 10 minutes, and then the mixed powder was taken out, dried at 40° C. for 3 hours by a hot air dryer, and further dried at 130° C. for 5 hours.
(3) The obtained powder was pulverized with a pulverizer (V Turbo available from FREUND-TURBO CORPORATION), thereby obtaining hydrophobized fine zinc oxide particles 1 having a hydrophobization rate of 71%.

### (Production Example ZH2) Preparation of Hydrophobized Fine Zinc Oxide Particles 2

Hydrophobized fine titanium zinc particles 2 having a hydrophobization rate of 76% were obtained in the same manner as in Production Example ZH1 except that the fine zinc oxide particles 1 were changed to the fine zinc oxide particles 2 and that the amount of aminopropyltriethoxysilane was changed from 910 g to 1270 g.

### (Production Example ZH3) Preparation of Hydrophobized Fine Zinc Oxide Particles 3

Hydrophobized fine titanium zinc particles 3 having a hydrophobization rate of 75% were obtained in the same manner as in Production Example ZH1 except that the fine zinc oxide particles 1 were changed to the fine zinc oxide particles 3 and that the amount of aminopropyltriethoxysilane was changed from 910 g to 1120 g.

### (Production Example ZH4) Preparation of Hydrophobized Fine Zinc Oxide Particles 4

Hydrophobized fine zinc oxide particles 4 having a hydrophobization rate of 35% were obtained in the same manner as in Production Example ZH1 except that the amount of aminopropyltriethoxysilane was changed from 910 g to 450 g.

### (Production Example ZH5) Preparation of Hydrophobized Fine Zinc Oxide Particles 5

Hydrophobized fine zinc oxide particles 5 having a hydrophobization rate of 90% were obtained in the same manner as in Production Example ZH1 except that the amount of aminopropyltriethoxysilane was changed from 910 g to 1150 g.

### (Production Example ZH6) Preparation of Hydrophobized Fine Zinc Oxide Particles 6

Hydrophobized fine titanium zinc particles 6 having a hydrophobization rate of 64% were obtained in the same manner as in Production Example ZH1 except that the fine zinc oxide particles 1 were changed to the fine zinc oxide particles 4 and that the amount of aminopropyltriethoxysilane was changed from 910 g to 290 g.

### (Production Example ZH7) Preparation of Hydrophobized Fine Zinc Oxide Particles 7

Hydrophobized fine titanium zinc particles 7 having a hydrophobization rate of 64% were obtained in the same manner as in Production Example ZH1 except that the fine zinc oxide particles 1 were changed to the fine zinc oxide particles 5 and that the amount of aminopropyltriethoxysilane was changed from 910 g to 260 g.

### Example 1

### Kneading (Melt-Kneading) Step

The following toner raw materials were introduced into an air flow mixer (Henschel mixer, available from Mitsui Mining Corporation (now NIPPON COKE & ENGINEERING CO., LTD.), model: FM20C) having a volume of 20 L, and pre-mixed at a rotational speed of 1500 rpm for 3 minutes, thereby obtaining a mixture. Binder resin: polyester resin (glass transition point: 52° C., softening temperature: 105° C.)
100 parts by mass (86.2 mass % in the toner core particles)
Colorant: cyan (C.I. Pigment Blue 15:3, product name: FASTOGEN (registered Japanese trademark) BLUE GR-6LK, available from DIC Corporation)
10 parts by mass (8.6 mass % in the toner core particles)
Charging control agent (product name: TRH, Hodogaya Chemical Co., Ltd.)
2 parts by mass (1.7 mass % in the toner core particles)
Release agent: carnauba wax (product name: Carnauba Wax TOWAX-131, available from Towa Kasei Co., Ltd.)
4 parts by mass (3.5 mass % in the toner core particles)

The obtained mixture was melt-kneaded using a twin-screw extruder (available from Ikegai Co., Ltd., model: PCM-30) under conditions: a cylinder setting temperature of 110° C., a barrel rotation speed of 150 rpm, and a raw material feeding rate of 15 kg/hour, thereby obtaining about 4 kg of a melt-kneaded product.

### [Pulverization (Cooling Pulverization) Step]

The obtained melt-kneaded product was cooled and solidified with a cooling belt and then coarsely pulverized using a power mill (available from Dalton Co., Ltd., model: P-3) having a φ2 mm screen, thereby obtaining a coarsely pulverized article having a particle size of about 2 mm.

The obtained coarsely pulverized product was finely pulverized using a jet pulverizer (available from Nippon Pneumatic Mfg. Co., Ltd., model: IDS-2), thereby obtaining a finely pulverized article having a particle size of about 6.7 μm.

### Classification Step

The resulting finely pulverized article was then classified using an elbow jet classifier (available from Nittetsu Mining Co., Ltd., model: EJ-LABO), thereby obtaining about 1 kg of toner core particles without external additives having a volume average particle size of 7.0 μm (coefficient of variation: 23%).

### External Addition Step

A toner with external additives (about 980 g) (volume average particle size: 7.0 μm, coefficient of variation: 23%) was obtained by placing 100 parts by mass of the obtained toner core particles, 1.3 parts by mass (external addition rate: 1.3 mass %) of silica particles (average primary particle size: 12 nm, treated with hexamethyldisilazane, product name: RX200, available from Nippon Aerosil Co., Ltd.) as an external additive, 5.0 parts by mass (external addition rate: 5.0 mass %) of the hydrophobized fine titanium oxide particles 1 (average primary particle size: 87.6 nm, hydrophobization rate: 67%) and 5.0 parts by mass (external addition rate: 5.0 mass %) of the hydrophobized fine zinc oxide particles 1 (average primary particle size: 102.9 nm, hydrophobization rate: 71%) as external additive components into an air flow mixer (Henschel mixer, available from available from Mitsui Mining Corporation (now NIPPON COKE & ENGINEERING CO., LTD.), model: FM20C), and mixing them for 1 minute with the peripheral speed at the outermost periphery of the tip of the stirring blade set at 40 m/sec.

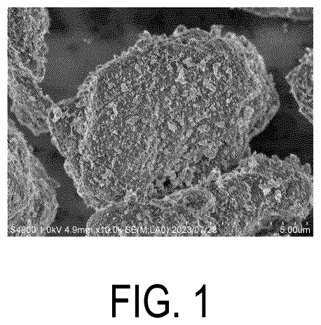

FIG. 1 is an SEM image of the toner with external additives obtained in Example 1.

### Preparation of Two-Component Developer

The resulting toner with external additives and a coat carrier (available from Sharp Corporation, name: Genuine Carrier for MX-6151) were placed in a V-shaped mixer (available from Tokuju Corporation, model: V-5) to give a toner concentration of 7.5 mass % and mixed for 20 minutes, thereby obtaining about 5 kg of a two-component developer.

### Production of Test Sheet

The obtained two-component developer was placed in a developing tank of a multifunction machine (available from Sharp Corporation, model: MX-6151), and a solid image of a 80 mm×80 mm patch was printed on an OHP sheet, thereby producing a test sheet 1 for antibacterial evaluation.

### Example 2

A toner 2 was prepared, and a test sheet 2 was produced, in the same manner as in Example 1 except that the external addition rate of the hydrophobized fine titanium oxide particles 1 was changed from 5.0 mass % to 3.3 mass % and that the external addition rate of the hydrophobized fine zinc oxide particles 1 was changed from 5.0 mass % to 6.7 mass % in the step of external addition to the toner.

### Example 3

A toner 3 was prepared, and a test sheet 3 was produced, in the same manner as in Example 1 except that the external addition rate of the hydrophobized fine titanium oxide particles 1 was changed from 5.0 mass % to 6.7 mass % and that the external addition rate of the hydrophobized fine zinc oxide particles 1 was changed from 5.0 mass % to 3.3 mass % in the step of external addition to the toner.

### Example 4

A toner 4 was prepared, and a test sheet 4 was produced, in the same manner as in Example 1 except that the external addition rate of the hydrophobized fine titanium oxide particles 1 was changed from 5.0 mass % to 3.5 mass % and that the external addition rate of the hydrophobized fine zinc oxide particles 1 was changed from 5.0 mass % to 3.5 mass % in the step of external addition to the toner.

### Example 5

A toner 5 was prepared, and a test sheet 5 was produced, in the same manner as in Example 1 except that the external addition rate of the hydrophobized fine titanium oxide particles 1 was changed from 5.0 mass % to 6.0 mass % and that the external addition rate of the hydrophobized fine zinc oxide particles 1 was changed from 5.0 mass % to 6.0 mass % in the step of external addition to the toner.

### Example 6

A toner 6 was prepared, and a test sheet 6 was produced, in the same manner as in Example 1 except that the hydrophobized fine titanium oxide particles 3 (average primary particle size: 76.1 nm, hydrophobization rate: 79%) were used instead of the hydrophobized fine titanium oxide particles 1 in the step of external addition to the toner.

### Example 7

A toner 7 was prepared, and a test sheet 7 was produced, in the same manner as in Example 1 except that the hydrophobized fine zinc oxide particles 3 (average primary particle size: 88.2 nm, hydrophobization rate: 75%) were used instead of the hydrophobized fine zinc oxide particles 1 in the step of external addition to the toner.

### Example 8

A toner 8 was prepared, and a test sheet 8 was produced, in the same manner as in Example 1 except that the hydrophobized fine titanium oxide particles 6 (average primary particle size: 192.4 nm, hydrophobization rate: 61%) were used instead of the hydrophobized fine titanium oxide particles 1 in the step of external addition to the toner.

### Example 9

A toner 9 was prepared, and a test sheet 9 was produced, in the same manner as in Example 1 except that the hydrophobized fine zinc oxide particles 6 (average primary particle size: 291.1 nm, hydrophobization rate: 64%) were used instead of the hydrophobized fine zinc oxide particles 1 in the step of external addition to the toner.

### Example 10

A toner 10 was prepared, and a test sheet 10 was produced, in the same manner as in Example 1 except that the external addition rate of the hydrophobized fine silica particles was changed from 1.3 mass % to 4.5 mass % in the step of external addition to the toner.

### Example 11

A toner 11 was prepared, and a test sheet 11 was produced, in the same manner as in Example 1 except that the external addition rate of the hydrophobized fine silica particles was changed from 1.3 mass % to 0.4 mass % in the step of external addition to the toner.

### Example 12

A toner 12 was prepared, and a test sheet 12 was produced, in the same manner as in Example 1 except that in the step of external addition to the toner, the peripheral speed at the outermost periphery of the tip of the stirring blade was set at 20 m/see instead of 40 m/sec.

### Example 13

Toner core particles without external additives having a volume average particle size of 7.0 μm (coefficient of variation: 24%) were prepared, a toner 13 was prepared, and a test sheet 13 was produced, in the same manner as in Example 1, except that in the step of preparing toner core particles, carbon black having an average primary particle size of 20 nm (product name: MA-100, available from Mitsubishi Chemical Corporation) was used instead of cyan as the colorant, and that the addition amount of carbon black was 8.0 parts by mass (internal addition rate: 7.0 mass %).

### Example 14

Toner core particles without external additives having a volume average particle size of 7.0 μm (coefficient of variation: 22%) were prepared, a toner 14 was prepared, and a test sheet 14 was produced, in the same manner as in Example 1, except that in the step of preparing toner core particles, 0.5 parts by mass (internal addition rate: 0.43 mass %) of carbon black having an average primary particle size of 20 nm (product name: MA-100, available from Mitsubishi Chemical Corporation) was further added in addition to cyan as the colorant.

### Example 15

Toner core particles without external additives having a volume average particle size of 7.0 μm (coefficient of variation: 21%) were prepared, a toner 15 was prepared, and a test sheet 15 was produced, in the same manner as in Example 13, except that in the step of preparing toner core particles, the addition amount of carbon black was changed from 8.0 parts by mass to 12.0 parts by mass (internal addition rate: 10.2 mass %).

### Example 16

Toner core particles without external additives having a volume average particle size of 7.0 μm (coefficient of variation: 23%) were prepared, a toner 16 was prepared, and a test sheet 16 was produced, in the same manner as in Example 13, except that in the step of preparing toner core particles, carbon black having an average primary particle size of 8 nm (product name: #2650, available from Mitsubishi Chemical Corporation) was used.

### Example 17

Toner core particles without external additives having a volume average particle size of 7.0 μm (coefficient of variation: 24%) were prepared, a toner 17 was prepared, and a test sheet 17 was produced, in the same manner as in Example 13, except that in the step of preparing toner core particles, carbon black 17 having an average primary particle size of 1200 nm produced in advance as described below was used.

### Production of Carbon Black 17

(1) An ester gum (30.0 parts by mass) (product name: Ester gum H, available from ARAKAWA CHEMICAL INDUSTRIES, LTD.) and 0.21 parts by mass of sodium hydroxide in an amount to neutralize the ester gum were added to 70.0 parts by mass of pure water, heated to 80° C. with stirring, and reacted for 1 hour with stirring, thereby preparing a rosin soap solution having a rosin component content of about 30%.
(2) Carbon black (40.0 parts by mass) (carbon black, product name: #45, available from Mitsubishi Chemical Corporation, average primary particle size: 24 nm, pH: 8.0), 40.0 parts by mass of the obtained rosin soap solution, 3.0 parts by mass of a surfactant-cum-antifoaming agent (product name: Surfynol 104, available from Nissin Chemical Industry Co., Ltd.), and 70.0 parts by mass of water were charged into a glass-bead-containing paint conditioner as a disperser, and vibrated for 90 minutes to finely disperse the carbon black.
(3) The obtained concentrated dispersion liquid was transferred to a disperser (available from PRIMIX Corporation, model: Homodisper model 2.5), water was added so that the carbon black content was 5%, and the mixture was stirred for 60 minutes, thereby obtaining a uniform dispersion liquid.
(4) Next, 105 parts by mass of a 5% aqueous solution of calcium chloride dihydrate was added, and stirring was further continued for 60 minutes.
(5) Thereafter, the dispersion liquid was heated to raise its temperature, and aged at 80° C. for 10 minutes.
(6) Carbon black was separated from the obtained dispersion by filtration, washed with water, and then dried at 70° C. for 24 hours, and coarse particles aggregated during drying were pulverized by a sample mill, thereby obtaining a carbon black powder having an average particle size of 1200 nm.

### Example 18

Toner core particles without external additives having a volume average particle size of 7.0 μm (coefficient of variation 24%) were obtained, a toner 18 was prepared, and a test sheet 18 was produced, in the same manner as in Example 13 except that carbon black 18 having an average primary particle size of 800 nm was used in place of the carbon black 17, the carbon black 18 being prepared in the same manner as in (4) in the method for producing carbon black 17 except that the amount of the 5% aqueous solution of calcium chloride dihydrate was changed from 105 parts by mass to 70 parts by mass.

### Example 19

A toner 19 was prepared, and a test sheet 19 was produced, in the same manner as in Example 1 except that the hydrophobized fine titanium oxide particles 5 (average primary particle size: 102.9 nm, hydrophobization rate: 35%) and the hydrophobized fine zinc oxide particles 4 (average primary particle size: 88.2 nm, hydrophobization rate: 35%) were used in the step of external addition to the toner.

### Example 20

A toner 20 was prepared, and a test sheet 20 was produced, in the same manner as in Example 1 except that the hydrophobized fine titanium oxide particles 4 (average primary particle size: 81.4 nm, hydrophobization rate: 90%) and the hydrophobized fine zinc oxide particles 5 (average primary particle size: 102.9 nm, hydrophobization rate: 90%) were used in the step of external addition to the toner.

### Comparative Example 1

A toner C1 was prepared, and a test sheet C1 was produced, in the same manner as in Example 1 except that the external addition rate of the hydrophobized fine titanium oxide particles 1 was changed from 5.0 mass % to 10 mass % and that the hydrophobized fine zinc oxide particles 1 were not used in the step of external addition to the toner.

### Comparative Example 2

A toner C2 was prepared, and a test sheet C2 was produced, in the same manner as in Example 1 except that the hydrophobized fine titanium oxide particles 1 were not used and that the external addition rate of the hydrophobized fine zinc oxide particles 1 was changed from 5.0 mass % to 10 mass % in the step of external addition to the toner.

### Comparative Example 3

A toner C3 was prepared, and a test sheet C3 was produced, in the same manner as in Example 1 except that the external addition rate of the hydrophobized fine titanium oxide particles 1 was changed from 5.0 mass % to 3.0 mass % and that the external addition rate of the hydrophobized fine zinc oxide particles 1 was changed from 5.0 mass % to 7.0 mass % in the step of external addition to the toner.

### Comparative Example 4

A toner C4 was prepared, and a test sheet C4 was produced, in the same manner as in Example 1 except that the external addition rate of the hydrophobized fine titanium oxide particles 1 was changed from 5.0 mass % to 7.0 mass % and that the external addition rate of the hydrophobized fine zinc oxide particles 1 was changed from 5.0 mass % to 3.0 mass % in the step of external addition to the toner.

### Comparative Example 5

A toner C5 was prepared, and a test sheet C5 was produced, in the same manner as in Example 1 except that the external addition rate of the hydrophobized fine titanium oxide particles 1 was changed from 5.0 mass % to 3.0 mass % and that the external addition rate of the hydrophobized fine zinc oxide particles 1 was changed from 5.0 mass % to 3.0 mass % in the step of external addition to the toner.

### Comparative Example 6

A toner C6 was prepared, and a test sheet C6 was produced, in the same manner as in Example 1 except that the external addition rate of the hydrophobized fine titanium oxide particles 1 was changed from 5.0 mass % to 7.0 mass % and that the external addition rate of the hydrophobized fine zinc oxide particles 1 was changed from 5.0 mass % to 7.0 mass % in the step of external addition to the toner.

### Comparative Example 7

A toner C7 was prepared, and a test sheet C7 was produced, in the same manner as in Example 1 except that the hydrophobized fine titanium oxide particles 2 (average primary particle size: 69.5 nm, hydrophobization rate: 70%) were used instead of the hydrophobized fine titanium oxide particles 1 in the step of external addition to the toner.

### Comparative Example 8

A toner C8 was prepared, and a test sheet C8 was produced, in the same manner as in Example 1 except that the hydrophobized fine zinc oxide particles 2 (average primary particle size: 78.6 nm, hydrophobization rate: 76%) were used instead of the hydrophobized fine zinc oxide particles 1 in the step of external addition to the toner.

### Comparative Example 9

A toner C9 was prepared, and a test sheet C9 was produced, in the same manner as in Example 1 except that the hydrophobized fine titanium oxide particles 6 (average primary particle size: 211.4 nm, hydrophobization rate: 65%) were used instead of the hydrophobized fine titanium oxide particles 1 in the step of external addition to the toner.

### Comparative Example 10

A toner C10 was prepared, and a test sheet C10 was produced, in the same manner as in Example 1 except that the hydrophobized fine zinc oxide particles 7 (average primary particle size: 323.3 nm, hydrophobization rate: 64%) were used instead of the hydrophobized fine zinc oxide particles 1 in the step of external addition to the toner.

### Evaluation

The (1) antibacterial properties and (2) image density were evaluated for the produced test sheets for evaluation of antibacterial properties and image density of Examples 1 to 19 and Comparative Examples 1 to 10 as follows.

### (1) Antibacterial Properties

The antibacterial activity values of the test sheets were measured in accordance with Antibacterial products-Test for antibacterial activity and efficacy (JIS Z2801:2012; revised on May 21, 2012), and the antibacterial properties were evaluated based on the following criteria.

### Evaluation Criteria

⊚: Activity value is 3.5 or more (high antibacterial properties are observed)
◯: Activity value is 3.0 or more and less than 3.5 (antibacterial properties are sufficiently observed)
Δ: Activity value is 2.0 or more and less than 3.0 (antibacterial properties are observed)
x: Activity value is less than 2.0 (antibacterial properties are not observed)

### (2) Image Density

White paper was laid on the back surface of the test sheet on which the image was printed, and the image density on the front surface side was measured using a densitometer (spectrophotometric colorimeter/densitometer X-Rite eXact, available from X-Rite Inc.).

From the measured value of the density, the image density was evaluated according to the following criteria.

### Evaluation Criteria

⊚: Image density is 1.30 or more (sufficient density is obtained)
◯: Image density is 1.25 or more and less than 1.30 (density is present)
Δ: Image density is 1.00 or more and less than 1.25 (minimum density is obtained)
x: Image density is less than 1.00 (density is insufficient)

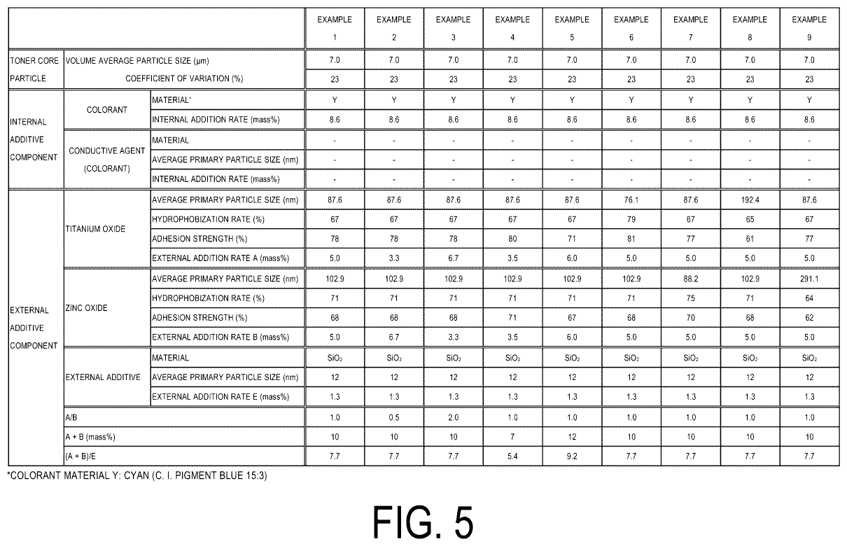

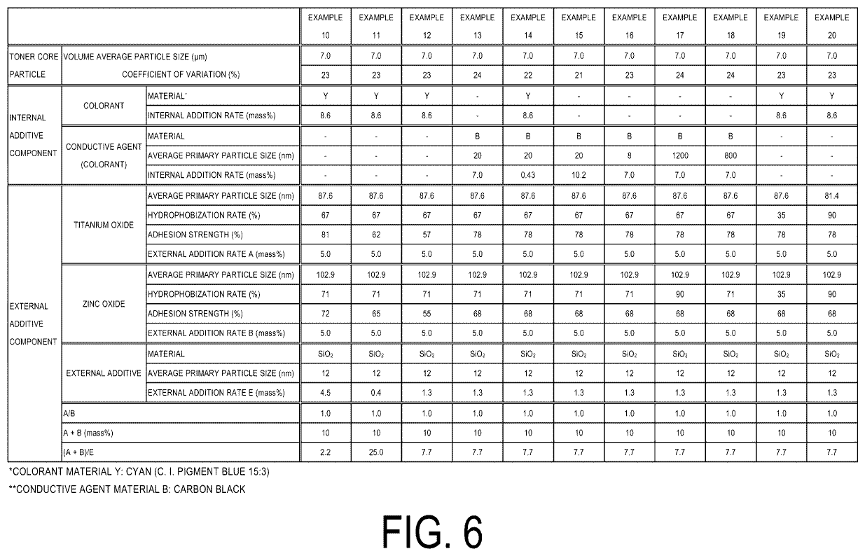

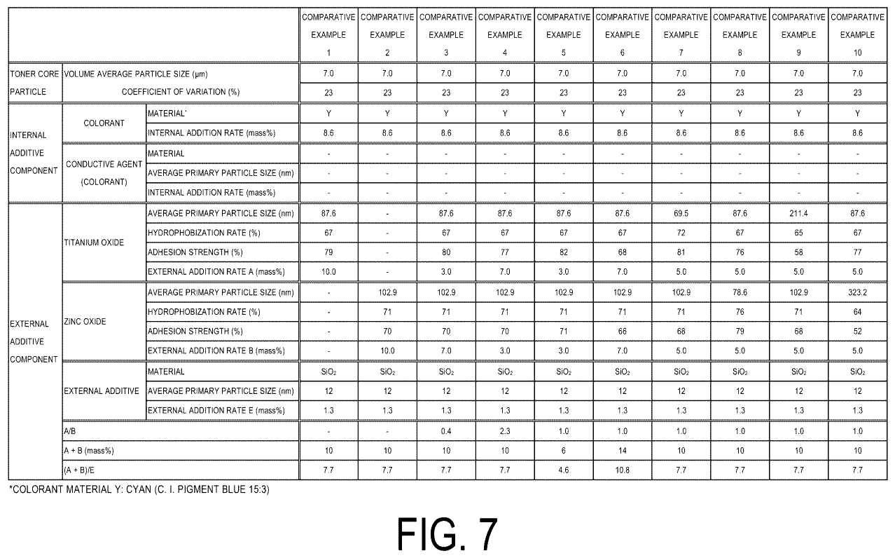

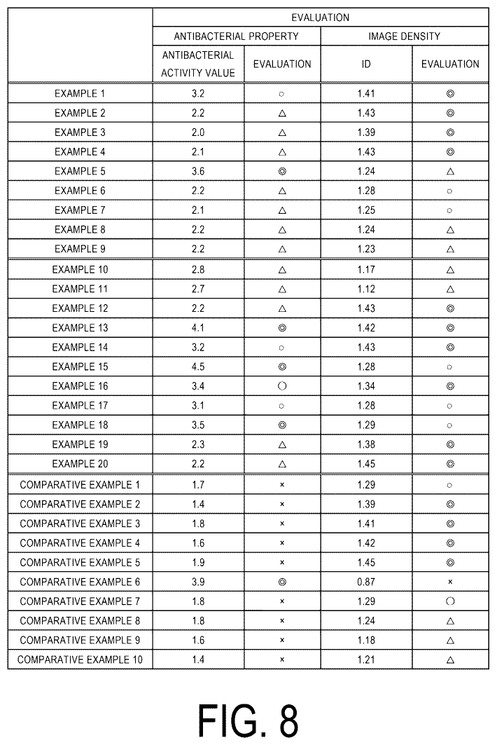

FIGS. 5 to 7 illustrate internal additive components and external additive components constituting the toner core particles and their physical properties values, and FIG. 8 illustrates evaluation results of test sheets produced using the obtained two-component developers.

In the evaluations of the (1) antibacterial properties and (2) image density, when at least either one of them was evaluated as “x”, it was determined that the toner was not actually usable, and the others were determined to be actually usable.

FIGS. 5 to 8 reveal the following.
(1) The toners including the constituent features of the disclosure and the two-component developers including the toners (Examples 1 to 20) are excellent in both antibacterial properties and image density, whereas the toners not including the constituent features of the disclosure and the two-component developers including the toner (Comparative Examples 1 to 10) are inferior.
(2) When the external addition rate ratio (A/B) between the titanium oxide particles and the zinc oxide particles is the lower limit value and the upper limit value (Examples 2 and 3, respectively), the synergistic effect between the two kinds of particles is weak. The antibacterial properties can be confirmed, but the effect thereof is weak.

On the other hand, when the external addition rate ratio (A/B) between the titanium oxide particles and the zinc oxide particles is less than the lower limit value and more than the upper limit value (Comparative Examples 3 and 4, respectively), the synergistic effect between the two kinds of particles is too weak, and the antibacterial properties are insufficient.
(3) When the total external addition rate (A+B) between the titanium oxide particles and the zinc oxide particles is the lower limit value and the upper limit value (Examples 4 and 5, respectively). The antibacterial properties can be confirmed, but the effect thereof is weak.

On the other hand, when the total external addition rate (A+B) between the titanium oxide particles and the zinc oxide particles is less than the lower limit value (Comparative Example 5), the external addition rate is too low and the antibacterial properties are insufficient. Also, when the total external addition rate exceeds the upper limit value, a sufficient antibacterial action can be confirmed, but the external addition ratio is too high and the toner chargeability is too low to obtain a sufficient image density.
(4) When the average primary particle size of the titanium oxide particles is the lower limit value (Example 6), the titanium oxide particles aggregate and the antibacterial effect is observed, but is reduced.

In addition, when the average primary particle size of the zinc oxide particles is the lower limit value (Example 7), the zinc oxide particles start to aggregate and the antibacterial effect is observed, but is reduced.

On the other hand, when the average primary particle size of the titanium oxide particles is the upper limit value (Example 8), the particles are large and thus easily detached from the toner surface. The detached titanium oxide is not developed, the concentration of the titanium oxide on the test sheet is low, and the antibacterial action is observed, but the effect thereof is reduced.

When the average primary particle size of the zinc oxide particles is the upper limit value (Example 9), the particles are large and thus easily detached from the toner surface. The detached zinc oxide is not developed, the concentration of the zinc oxide on the test sheet is low, and the antibacterial action is observed, but the effect thereof is reduced.
(5) When the average primary particle size of the titanium oxide particles is less than the lower limit value (Comparative Example 7), the titanium oxide particles aggregate, and no sufficient antibacterial action can be confirmed.

When the average primary particle size of the titanium oxide particles is less than the lower limit value (Comparative Example 8), the zinc oxide particles aggregate, and no sufficient antibacterial action can be confirmed.

On the other hand, when the average primary particle size of the titanium oxide particles exceeds the upper limit value (Comparative Example 9), the particles are too large and thus excessively detached from the toner surface, and the detached titanium oxide particles are not developed. The concentration of titanium oxide on the test sheet is low, and the antibacterial action is not observed.

In addition, when the average primary particle size of the zinc oxide particles exceeds the upper limit value (Comparative Example 10), the zinc oxide particles are large and thus easily detached from the toner surface. The detached titanium oxide particles are not developed, and the concentration of zinc oxide on the test sheet is too low, and the antibacterial action cannot be confirmed.
(6) When the external addition rate of the hydrophobic fine silica particles as the external additive is high and the ratio (A+B)/E between the total external addition rate (A+B) of the titanium oxide particles and the zinc oxide particles and the external addition rate E of the external additive is less than the lower limit value (Example 10), the charging of the toner is high, the image density is low, and the antibacterial action is confirmed, but the effect thereof is reduced.

When the external addition rate of the hydrophobic fine silica particles as the external additive is low and the ratio (A+B)/E between the total external addition rate (A+B) of the titanium oxide particles and the zinc oxide particles and the external addition rate E of the external additive exceeds the lower limit value (Example 11), the fluidity of the toner is poor, the image density decreases, and the antibacterial action can be confirmed, but the effect thereof is reduced.
(7) When the adhesion strengths between the titanium oxide particles and the zinc oxide particles are both less than the lower limit values (Example 12), these particles are detached from the toner, and the external addition rate of the particles developed on the sheet is reduced accordingly. Therefore, the antibacterial action is observed, but the effect thereof is reduced.
(8) when the toner core particles further contain carbon black having conductivity (Example 13), the carbon black enters between the titanium oxide particles and the zinc oxide particles, the contact opportunity between the titanium oxide particles and the zinc oxide particles increases, the synergistic effect is increased, and the antibacterial action is improved.

In addition, when the internal addition rate of the carbon black to the toner core particles is low and is less than the specified value of 1 mass % (Example 14), a sufficient antibacterial action is observed, but an effect of improving the antibacterial action due to increase in synergistic effect is hardly observed.

On the other hand, when the internal addition rate of the carbon black to the toner core particles is high and exceeds the specified value of 10 mass % (Example 15), the effect of improving the antibacterial action due to the increase in synergistic effect is observed, but the toner chargeability decreases and the image density is adversely affected.
(9) When the volume average particle size of the carbon black is small and less than the specified value of 10 nm (Example 16), the carbon black is hardly dispersed in the toner and the antibacterial action can be confirmed, but the effect of improving the antibacterial action due to increase in synergistic effect is weak.

On the other hand, when the volume average particle size of the carbon black is large and exceeds the specified value of 1000 nm (Example 17), a sufficient antibacterial action is observed, but the contact opportunity between the titanium oxide particles and the zinc oxide particles cannot be efficiently increased, and the effect of improving the antibacterial action is hardly observed.
(10) When the hydrophobization rates of the titanium oxide particles and the zinc oxide particles are less than the specified value of 40% (Example 19), the aggregation of the particles cannot be sufficiently prevented, and the antibacterial action is observed, but the effect thereof is low.

In addition, when the hydrophobization rates of the titanium oxide particles and the zinc oxide particles exceed the specified value of 80% (Example 20), the opportunities of contact between the particles and elution of metal ions from the surfaces of the particles are reduced, and the antibacterial action is observed, but the effect thereof is low.
(11) When the volume average particle size of the carbon black is close to the upper limit value (1200 nm) of the specified value (Example 18), the antibacterial effect is good but inferior to that when the volume average particle size of the carbon black is 20 nm (Example 13).
(12) When the titanium oxide particles are used alone (Comparative Example 1), a certain level of antibacterial effect is observed, but there is no synergistic effect with the zinc oxide particles, resulting in insufficient antibacterial effect.

On the other hand, when the zinc oxide particles are used alone (Comparative Example 2), a certain level of antibacterial effect is observed, but there is no synergistic effect with the titanium oxide particles, resulting in insufficient antibacterial effect.

1. A toner comprising at least toner core particles and an external additive component externally added to the surface of the toner core particle,
wherein the external additive component contains at least titanium oxide particles, zinc oxide particles, and an external additive,
the titanium oxide particles and the zinc oxide particles have average primary particle sizes of from 75 to 200 nm and from 80 to 300 nm, respectively, and
when external addition rates of the titanium oxide particles and the zinc oxide particles with respect to the toner core particles are defined as A mass % and B mass %, respectively, the toner satisfies relationships of the following formulas (1) and (2):
$$0.5 \leq A / B \leq 2. \qquad ( 1 )$$
$$7 \leq ( A + B ) \leq 12. \qquad ( 2 )$$

2. The toner according to claim 1, wherein, when external addition rates of the titanium oxide particles, the zinc oxide particles and the external additive with respect to the toner core particles are defined as A mass %, B mass % and E mass %, respectively, the toner satisfies a relationship of the following formula (3):
$$2.5 \leq ( A + B ) / E \leq 20. \qquad ( 3 )$$

3. The toner according to claim 1, wherein each of the titanium oxide particles and the zinc oxide particles has an adhesion strength of from 60% to 100%.

4. The toner according to claim 1, wherein the titanium oxide particles and the zinc oxide particles each have a hydrophobization rate of from 40 to 80%.

5. The toner according to claim 1, wherein the toner core particles further contain a conductive agent.

6. The toner according to claim 5, wherein the conductive agent has a volume average particle size of from 10 to 1000 nm and is contained in the toner core particles at an internal addition rate of from 1 to 10 mass %.

7. The toner according to claim 5, wherein the conductive agent is carbon black.

8. A two-component developer comprising the toner according to claim 1 and a carrier.
